(19) United States
(12) Patent Application Publication
(10) Pub. No.: US 2004/0177357 A1
(43) Pub. Date: Sep. 9, 2004

(54) Web-based presentation of automation processes

(75) Inventors: Rainer Heller, Eckental (DE); Thomas Jachmann, Nurnberg (DE); Jorg Middel, Ernskirchen (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 10/771,504

(22) Filed: Feb. 5, 2004

(30) Foreign Application Priority Data
Feb. 5, 2003 (DE) 10304646.1

(51) Int. Cl. G06F 9/46

(52) U.S. Cl. 718/100

(57) ABSTRACT

Web-based presentation of data is processed in a system for operating and observing a process. Up-to-date process values are automatically transmitted by a server or an automation unit to a client, on which they are visualized using scalable vector graphics and the application of SVG.

### CROSS REFERENCE TO RELATED APPLICATIONS

This application is based on and hereby claims priority to German Application No. 10304646.1 filed on Feb. 5, 2003, the contents of which are hereby incorporated by reference.

### BACKGROUND OF THE INVENTION

The invention relates to a system, to a method, to a client and also to an automation unit for presenting dynamic data for operating and observing a process, particularly in the automation environment.

The provision of information at different locations is becoming increasingly important. Some of the information to be provided is subject to certain dynamics in this context, i.e. the information is not available statically, but rather is subjected to regular or irregular changes. There is accordingly a need to present information which changes at arbitrary intervals of time at another location independently of its place of origin or source. In this context, information is frequently presented in the form of graphics and possibly additionally through a text display. Such graphics can be presented independently of location using special computer systems, for example, “Systems for operation and observation”. These are abbreviated to O&O systems below.

Such O&O systems are used primarily in the industrial sector. By way of example, data collected in the course of a production or fabrication process relating to information about the respective process are provided for a user or operator of the production installation for information and monitoring purposes using an O&O system in the automation environment. In this context, these data originating from a running automation process are subject to constant alterations, and are thus dynamic data which depict the current state of a process.

Since the process values displayed in the O&O system are normally used for monitoring an automated process, e.g. a fabrication process, a typical demand on the presentation of these data is that the displayed values be updated at a time which is close to the occurrence of the event, that is to say e.g. a change in a value. The data visualized by the graphics in the O&O system need to be updated in line with the changes in the process values. The graphics in an O&O system are therefore typically not static, but rather visualize the process values using animations or altered presentations. As the level of automation increases, the demands on the graphics in an O&O system also rise in this context.

Since the information and process values are generally provided or presented and displayed at a different location than the source of the respective values, the information is generally transmitted from the location of the source to the location of use using various communication techniques. To achieve the greatest level of independence possible when using O&O systems, the use of web technologies is appropriate. In this context the dynamic process values are displayed on a client using a web browser, which means that a web-based O&O system can be implemented in this way, for example.

However, standard web browsers directly support only presentation of graphics in the form of static images coming from a server. A generic product for graphics is currently achieved by dynamically creating graphics using the changed process values on the server and by subsequently transmitting the newly created graphics to the client for display. In this context, the presentations in a web browser are page based, which means that it is generally always necessary to request whole pages from the server. In this context, the presentation of a dynamic process, for example the display of an analog thermometer or the display of a filling level for a tank, requires constant rerequesting of the page provided by the server in order to be able to display the current values.

In order to be able to use standard web clients within the framework of O&O systems nevertheless, Java applets and ActiveX controls are used today. However, these tie the user of the O&O system to particular hardware platforms, require special software components to be installed and represent uncertainty factors.

### SUMMARY OF THE INVENTION

One possible object of the present invention is to allow improved display of changing data (dynamic data), particularly of process values within the framework of an automation solution, on a web-based system for operation and observation (O&O system).

The object is achieved by a system for presenting and/or displaying dynamic data for operating and observing a process, particularly process data in a fabrication and/or manufacturing process in the automation environment, having at least one first apparatus for providing the dynamic data, at least one second apparatus for receiving the dynamic data, where the second apparatus has a device for visualizing the dynamic data, a transmission apparatus for the first apparatus to communicate with the second apparatus, where the dynamic data provided by the first apparatus are intended for automatic transmission between the first apparatus and the device for visualization, and where the visualization of the dynamic data is provided by scalable vector graphics

One aspect of the invention is based on the insight that it is advantageous if changing information, referred to in this case as dynamic data, can be presented at a high graphical level under event control and independently of location. Within the context of an automation system, such information can be process values which are collected directly from the production process and need to be visualized, by way of example, on a system for operation and observation at another location for an installation operator. In this context, it is particularly important that the process values, that is to say the dynamic data, be presented in real time and under event control.

The proposed automatic transmission of the dynamic data allows real-time and event-controlled presentation of these data. The use of the scalable vector graphics allows the creation of complex graphics, for example random graphics. The implementation of automatic transmission of the changing data produced provides a user of the system automatically with the respectively most up-to-date information without the need for any action by the user to acquire the data. Updating the information and constantly retrieving new information becomes superfluous.

The data can be received and presented by a plurality of apparatuses, in which case the apparatuses can access the data independently of one another. It is likewise possible for an apparatus which receives data and subsequently visualizes them to access a plurality of apparatuses providing data. This means that the data can be used as often and as flexibly as desired within the framework of the system, and data from different sources can be visualized on one display. This allows a high freedom of form in relation to presentations of detail or else combined visualizations.

Another advantageous refinement is characterized in that the transmission apparatus is in the form of an intranet and/or the Internet. The use of the intranet or Internet for transmitting information, particularly for transmitting process values which are produced in an automation process, is particularly suitable, since a high level of flexibility is made possible. By way of example, the user of an O&O system in an installation can be situated at any location and can display data using the O&O system if the transmission apparatus used is an intranet or the Internet. Besides the independence of location, another advantage of using an intranet or the Internet is that standard methods can be used within the context of the data transmission. There is no need for any specific form of data transmission protocol in this case. This ensures simple and flexible transmission of dynamic data, particularly of process values.

Another advantageous refinements characterized in that the first apparatus for providing the dynamic data is in the form of a server, particularly in the form a web server. When a web server is used as one possible embodiment of the system, it is largely possible to resort to standard techniques for the data transmission. This ensures simple provision of data for transmission via an intranet or the Internet. It is likewise advantageous that the data are available generally to authorized users of these data within the framework of the system. All authorized users can then access the provided data selectively and repeatedly.

Another advantageous refinement of the system is characterized in that the first apparatus for providing the dynamic data is in the form of an automation unit with web server functionality. This allows direct use and processing of information, for example of process values which are requested or collected directly from the automation unit. The use of a server to provide the appropriate data is not necessary in this case. Increasing flexibility and increasing scalability of the overall system are made possible in this manner. In this case, the data are transmitted using web services such as OPC XML, for example. Besides the flexibility and scalability, the reduction of costs is an advantage of this possible, but not imperative, refinement. This variant dispenses with costly procurement of servers for the purpose of providing the information or data.

Another advantageous refinement is characterized in that the second apparatus for receiving the dynamic data is in the form of a client, particularly in the form of a web client, and/or in that the unit for visualizing the dynamic data are in the form of a browser. In this case, the client used can be a multiplicity of different apparatuses. By way of example, it is possible to use PCs, workstations or else any mobile units such as WebPads, Palm Pilots or else mobile telephones with web capability. In this context, a web browser is just one specific form. In this case, it is generally possible to refer to web clients capable of processing and displaying web contents.

The use of a web client with a browser for visualizing the arising dynamic process data in the form of graphics within the context of an O&O system is particularly advantageous, since the data transmission can take place on the basis of standard protocols. When the intranet or Internet is used for the data transmission, a high level of flexibility is also achieved for the user of the O&O system. Specifically when a web client is used, the user can download the information, particularly the process values, to his client at any locations and can visualize the information in the form of web pages using the browser. Specifically the use of “browsers”, standard applications for presenting web pages, is advantageous, since today a large quantity of potential users of the system is familiar with how to use a standard browser, which means that there is no need for complex training. This permits simple and inexpensive application and use of the system.

Another advantageous refinement is characterized in that the dynamic data are intended for a presentation which is independent of the screen resolution and/or of the zoom factor. This allows the presentation of graphics in O&O systems to be implemented independently of the display opportunities, such as the screen resolution of web clients. Similarly, this allows the user of such a system to visualize different levels in terms of detail accuracy of the presentation of the information. The automatic scalability of the presentation of the information thus ensures alignment with any applications and clients.

Another advantageous refinement of the system is characterized in that the intended language for creating the scalable vector graphics is SVG, Scalable Vector Graphics. SVG is a recommendation from the W3C, or a standard for scalable vector graphics. SVG is a language for describing the presentation and animation of graphics on web pages. SVG has been developed specifically for the web and is XML based. SVG also runs under the head word “HTML for graphics”. The advantages of SVG are, inter alia, that it is a platform-independent, interchangeable description language for graphics. Such graphics can thus be displayed on any systems, for example any web clients, without the need for further installations of appropriate components. SVG supports the creation of complex graphics as a result of superior functions. By way of example, it is possible to create Bezier curves or curve lines. Besides this, SVG allows the creation of libraries of graphics components and multiple use thereof in the creation of graphics. It is also possible to create dynamic graphics through the opportunity for interacting with the graphics, for example by a mouse click, or by defining animation paths. The use of SVG within the framework of the system thus allows improved creation of graphics, which results in better presentation of the information for the end user. This in turn results in an improvement in the overall O&O system, since better visualization of the relevant information achieves a higher level of operating certainty.

Another advantageous refinement is characterized in that the first apparatus is intended to provide the dynamic data in the form of web services. The web services provided can be called up from any clients, particularly from web browsers. This lays the foundation stone for a web-based O&O system. The advantage is that only the web paradigm and its standards are being backed. A further, platform-linked technology, such as ActiveX Controls, is dispensed with. Similarly, there is no longer any need for special solutions requiring, by way of example, an “infinite download” to be implemented. Instead, the data are permanently available for retrieval and can be automatically called up by the browsers. The web services provided by the servers and/or automation devices are standardized web technology. The use of this standard within the context of the proposed method results in a cost saving and simplifies application of the system.

Another advantageous refinement is characterized in that the data provided by the first apparatus in the form of web services are intended to be called up and/or retrieved by the visualization unit. Within the framework of the system, the process values, or the dynamic data, which have been changed and need to be revisualized after they have changed are thus called up from the client itself. This involves the use of a “Pull principle”, where the data are retrieved when the client is able to process them. This results in less network load and need-oriented data transmission.

Another advantage in this context is that the O&O interface to be displayed (web page) does not have to come from a server, but rather is available locally on the client or in the client application and is filled with data from the process, via a web service. In this case, however, the web client is not a simple standard web browser, but rather an application using the web technology.

The information and data can be updated such that they need to be fetched only when they have changed, and a detailed description of the procedure can be found in German Patent Publication No. 102 42 918.9-53.

The system presented is also advantageous, in particular, on account of the opportunity to use standard techniques for implementation. Most browsers have scripting (e.g. ECMA script) at the client end, which is a standardized language for use in web browsers.

As a result, the browser on the client provides the option of updating only those data which have changed. An event-controlled procedure, as is wanted in O&O systems, thus also becomes implementable in the web environment. This results in simple usability and allows a greater spread for the O&O systems within the context of the automation environment.

Another advantageous refinement of the system is characterized in that the first apparatus is intended to provide the updated dynamic data using hidden frames. In this context, the information or process values is/are stored in the up-to-date form on the web server, for example, and is/are “displayed” on a web page which cannot be seen.

Another advantage of implementing O&O systems on the basis of the proposed system is that there is no need for any graphical presentation of the process values on the web server. The corresponding information or values is/are not presented until after retrieval, for example by a browser, which sometimes uses special style sheets and in that case displays the data in the form wanted at that point. The data on the server/automation component can be stored in a form which is independent of presentation. The data are then not put into the graphical form until on the client. This provides the option of presenting the data in different ways on different clients for different users. By way of example, a user of an O&O system can compile his web page himself and can retrieve the process values to be presented as basic data from the server. The form of presentation is then up to the user. This advantageous refinement allows the greatest possible flexibility and alignment of the O&O system with the needs of the user, resulting in individually tailored provision of information.

Another advantageous refinement is characterized in that the first apparatus is intended to transmit the updated dynamic data to the second apparatus using a streaming media mechanism. In this context, the server is constantly sending updated values to the client. In this case, the client keeps the connection to the server open. The data are transmitted from the server to the client in accordance with a push model. The use of this possible, but not exclusive, application is advantageous if a large volume of data is changing in a short period of time anyway and constant alignment of the data's up-to-date status is not necessary. In this case, the use of the push model for data transmission is an efficient and simple embodiment.

Another advantageous refinement is characterized in that the second apparatus is intended for wireless communication using the transmission apparatus. This allows a user to use the screen or client on which the graphics presenting the information are displayed at any location. In this advantageous embodiment, the data are transmitted using a WLAN or by radio, for example. The user of an O&O system is thus provided with the greatest possible freedom of movement in his work.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic illustration of a web-based display of information,

FIG. 2 shows an exemplary graphical illustration of dynamic process values in an O&O system,

FIG. 3 shows a program flowchart with the exemplary description of a scalable vector graphic,

FIGS. 4, 5 and 6 show program flowcharts illustrating the connection between graphics and process values.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

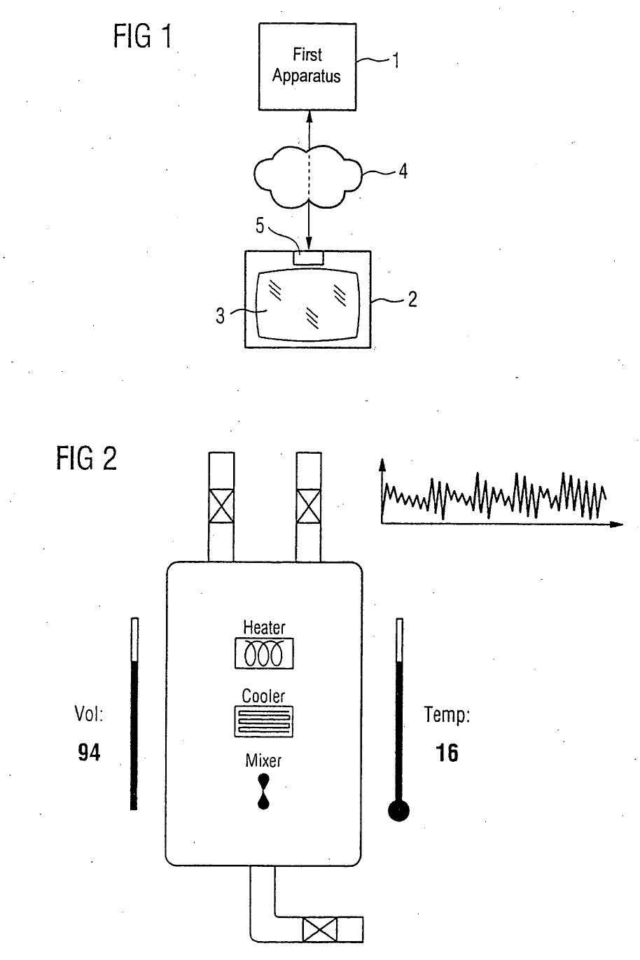

FIG. 1 shows a schematic depiction of the system for presenting information or dynamic data. In this context, data are provided by a first apparatus 1. This first apparatus 1 can be, by way of example, a server, particularly a web server. In another embodiment, however, the data can be provided by an automation unit, for example a mixer or a heater (or their control unit). The data are transmitted to a second apparatus 2 using the data transmission apparatus 4. The second apparatus 2 can be a client, for example a web client. This client can be in the form of a “Thin client” and can communicate with the first apparatus 1 wirelessly, if appropriate, using a WLAN. The transmission apparatus 4 can be a decentralized network, such as the Internet or an intranet. The dynamic data are presented on the second apparatus 2 by a visualization unit 3. The visualization unit 3 can be a standard web browser. To receive the data, the client has a reception apparatus 5. The data are presented on the client in the browser using “Scalable vector graphics”, specifically Scalable Vector Graphics technology.

The text below outlines the basic procedure for using the system shown in FIG. 1, using the example of a client/server system. However, it is also conceivable to use other embodiments of the first apparatus 1, which is represented by a server in the example. The first apparatus can be, by way of example, an automation unit or any apparatus on which dynamic data arise and which also provides them.

1. A server uses web services (standardized web technology) to provide the process values for an automation or production process.

2. The client requests the web page from the web server.

The web page or its design can be firmly prescribed (e.g. by the planner) and contains graphical presentations and representations of process values.

The web page can also have been compiled by the user himself by virtue of his having selected the process values to be presented and their form of presentation using a portal, for example.

The web page contains information about which process values need to be displayed in the web page. This can be done, for example advantageously, in the form of an XML data island, or else can be used just temporarily in order to set variables and attributes.

In addition, the page also contains references for SVG files describing graphical presentations and animations. By way of example, they can be provided as a graphics library containing standard elements such as pointer instruments, bar graphs value displays etc.

A “glue code” connects the request for process values and control of the graphics in order to perform appropriate animation/visualization of the process values. This code is stored in the page. The client-side script code (e.g. ECMAScript)” “wires up” the values received from the server and the SVG graphics elements which are presented.

3. In the web browser, the client receives the (process) values to be displayed from the server and presents them in graphical form and/or as text. In this case, various mechanisms for data transport to the client are possible. These have different uses.

A client can update (poll) a page (e.g. of a hidden frame) directly, for example, and can thus ascertain the data for the display.

A client can also use a web service in order to request the data directly (e.g. with web service client behaviors within Internet Explorer) and can thus poll the data directly. A variant of this is the use of a web service which can give information regarding whether changed values are available and retrieves these only if required. This optimizes access and bandwidth used.

Another alternative is to receive the data using a streaming media mechanism. In contrast to the previous solutions, this corresponds to a push model, since in this case the server sends constantly updated values to the client. The client keeps a connection to the server open.

4. The combination of standard web page with SVG presentation elements, retrieval of up-to-date data from the server and client-side script code for connecting up SVG elements and data allows the requirements of an O&O interface to be met in the web environment too. In this case, the underlying techniques are all standardized web techniques.

Operation is performed “conventionally” using the techniques of the web, such as revealing buttons, selective locations in the graphics, input fields etc.

These events and data can then be returned to the server again so as to trigger control functionality there or else just to switch between web pages/O&O images.

The system shown FIG. 1 affords the following advantages:

The option of graphically presenting process values without a round trip is provided (it is not necessary to request the entire web page, but rather just the up-to-date data when they have changed). Text and contents of transmitted web pages are maintained and can be interpreted at the client end.

Seamless integration in the XML world is provided: avoidance of a presentational and technical “break”, as would inevitably occur with ActiveX controls or Java applets.

The use of the power of SVG to represent/generate dynamic graphics is possible.

The power of standard communication using web service technology is used. This means that no reimplementation of communication in ActiveX controls or Java applets is necessary.

One advantage is the scalability of the server application through statelessness. No permanent connection to the server is necessary.

The system has an unrestricted firewall capability.

Simple use is possible and the system is based exclusively on standard web technologies.

There is a high level of security as a result of the avoidance of security-critical techniques.

Besides an SVG Viewer, which needs to be installed once on the client (and which will be a firm component anyway in the next versions of the browsers), no other installation is necessary at the client end.

The necessary bandwidth between client and server is relatively small.

The creation of SVG graphics and pages is supported by a toolscape on graphics programs.

A web service access point to the data is already available in future anyway (e.g. via OPC XML). The existence thereof can be used here.

As vector graphics, SVG is freely scalable, i.e. automatic alignment with screen sizes is easily possible.

It is possible to use (SVG) graphics libraries when creating web pages too.

The seamless integration of the SVG elements into the surrounding HTML page ensures continuity in the presentation, particularly also as a result of the joint usability of cascading style sheets (W3C standardized).

Combination with other technologies is possible (mixed pages using HTML text, bitmaps, video etc.).

It is a simple matter to connect to a plurality of servers providing process values.

It is a simple matter for a graphic to be (subsequently) extended by further visualization of process values.

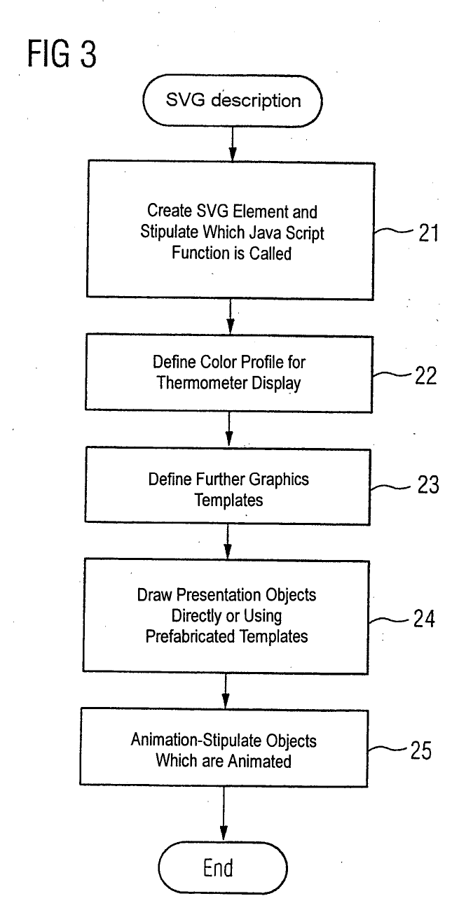

FIG. 2 shows a graphic created using SVG (Scalable Vector Graphics). This graphic contains visualizations of various automation components. Thus, process values are visualized directly in text form and also by additional graphical elements which change their color/shape/degree of fill on the basis of the process values. Beyond static images which can present, by way of example, the valves shown only on a fixed basis, SVG makes it possible to animate their state as well and to present their position accordingly. The characteristic curve on a yellow background shows the time profile for a process value. The entire presentation of the image is made in a standard web browser and is purely XML/HTML based. The current process values are fetched directly from a web service using web service behavior. Scripting code sets the process values as attributes of SVG elements of the graphics. Technically, this is done by constructing a DOM (Document Object Model) using the SVG image, which is represented by XML, and setting attributes for elements in the tree.

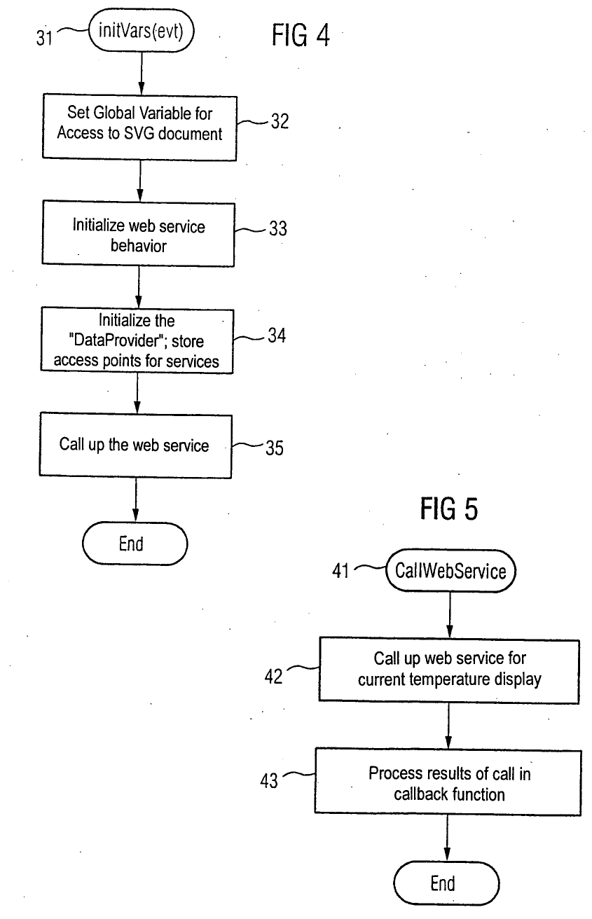

FIG. 3 shows a flowchart for the description of an exemplary graphic. The XML sequence below represents the SVG description of the graphic shown in FIG. 2. This is used for the description of reusable library elements, for the declarative creation of the graphic and its animation components.

Action 21: create an SVG element and stipulate which JavaScript function (initVars(evt)) is called up when the SVG element is loaded

<?xml version=“1.0” encoding=“iso-8859-1”?>
<!DOCTYPE svg PUBLIC “-//W3C//DTD SVG 20000303 Stylable//EN”

“http://www.w3.org/TR/2000/03/WD-SVG-20000303/DTD/svg-20000303-styleable.dtd”>

<svg viewBox=“0 0 1500 1500” onload=“initVars(evt)”>

Action 22: define the color profiles for the thermometer display

<linearGradient id=“BlendLinear” gradientU-

nits=“userSpaceOnUse” x1=“0” y1=“950” x2=“0” y2=“450”>
<stop offset=“0%” style=“stop-color:red” /> <stop off-set=“100%” style=“stop-

color:blue” />

</linearGradient>
<linearGradient id=“BlendLinear2” gradientU-

nits=“userSpaceOnUse” x1=“0” y1=“950” x2=“0” y2+“450”>
<stop offset=“70%” style=“stop-color:red” /> <stop offset=“100%” style=“stop-

color:blue” />

</linearGradient>
<linearGradient id=“BlendLinear3” gradientU-

nits=“userSpaceOnUse” x1=“0” y1=“950” x2=“0” y2=“450”>
<stop offset=“0%” style=“stop-color:red” /> <stop off-
set=“30%” style=“stop-color:blue” />

</linearGradient>

Action 23: define further graphics templates, such as valves, heating coil for later drawing operations

<defs>

<g id=“Valve”> <path d=“M0 1100 0 1-100 100 1100 0 1-
100-100z”/></g>

<g id=“falve” transform=“translate(−36,−36)”>

<polygon points=“0,0 72,0 0,72 72,72” /> </g>
<g id=“Auslauf”>

<path d=“M0 0 10 170 c0, 10 20,30 30,30 1270 0 10 -

80 1-200 0 c-15,0 -20,−5 -20,−20 10 -100 z” sty-
le=“fill:lightgray; stroke:powderblue; stroke-width:6”/>
</g>

<path id=“m1” transform=“translate(−16)” d=“M16,0 c0,0-16,24, −16,33 c

0,9 7,15 16,15 c 9,0 16,−7 16,−15c 0,−9 -16,−33 -16,−33” />

<g id=“mixerbase”>

<use xlink:href=“#m1” />
<use xlink:href=“#m1” transform=“rotate (180)”/>
<circle cx=“0” cy=“0” r=“5”/>

/g>

<path id=“h” style=“fill:none;stroke-width:3” d=“M0,0 c 12,3 16,13 18,16 c0,0-

16,24, −16,33 c 0,9 7,15 16,15 c 9,0 16,−7 16,−15c 0,−9 -16,−33 -16,−33 c 2,−3 6,−13 18,−16” />

<g id=“sp”>
<use xlink:href=“#h” />

<use xlink:href=#h” transform=“translate(36)” />
<use xlink:href=#h” transform=“translate(72)” />
</g>
<path id=“co” style=“fill:none;stroke-width:3” d=“M0,0 1-130,0 10,10 1130,0” />
<g id=“coolersp”>

<use xlink:href=“#co” transform=“translate(130)” />
<use xlink:href=“#co” transform=“rotate (180) translate(0,−20)” />
<use xlink:href=“#co” transform=“translate (130,20)” />
<use xlink:href=“#co” transform=“rotate(180) translate(0,−40)” />
<use xlink:href=“#co” transform“translate(130,40)” />

</g>

</defs>

Action 24: draw the presentation objects (boiler, inlets, outlets, filling level display, text, . . . ) either directly or using the prefabricated templates

<g>

<g transform-“translate(850,50)”>
<rect x=“0” y=“0” width=“600” height=“150” style=“fill:yellow;”/>
<g transform=“translate(5,5)”>

<path d=“M0,0 10,140 1595,0” style=“fill:none;stroke:blue;

stroke-width:5”/>

<path id=“Graph1” d=“M0,140” style=“fill:none; stroke:blue;

stroke-width:2”/>

</g>
</g>
<rect id=“body” x=“300” y=“300” width=“500” height=“800”

style=“fill:lightgray; stroke:powderblue; stroke-width:6” rx=“10” ry=“20” />

<g>
<rect id=“body” x=“400” y=“10” width=“80” height=“290”

style=“fill:lightgray;fill-opacity:1.0; stroke:powderblue; stroke-width:6” rx=“10” ry=“20”/>

<use id=“Valve1” xlink:href=“#falve” x=“441” y=“156”/>
</g>
<g>
<rect id=“body” x=“620” y=“10” width=“80” height=“290”

style=“fill:lightgray; stroke:powderblue; stroke-width:6” rx=“10” ry=“20” />

<use id=“Valve”2 xlink:href=“#falve” x=“661” y=“156” />
</g>
<use id=“xxx” xlink:href=“#Auslauf” x=“510” y=“1100” />
<use id=“Valve3” xlink:href=“#falve” x=“690” y=“1262”

transform=“rotate(0)”/>

<circle id=“yyy” cx=“900” cy=“950” r=“30” style=“fill:red” />
<rect id=“temperatur” x=“893” y=“450” width=“14” height=“500”

style=“fill:url(#BlendLinear3)”/>

<g transform=“translate(210,450)” >
<rect x=“0” y=“0” width=“14” height=“500” style=“fill:blue; stroke:black;

stroke-width:3”/>

<rect id=“fillingLevel” x=“0” y=“0” width-“14” height=“500” style=“fill:white”

transform=“scale(1,1)/>

</g>
<text id=“heatertext” style=“font-size:18pt” x=“515” y=“490”>
Heater
</text>
<rect id=“heater” x=“475” y=“500” width=“150” height=“80”

style=“fill:orchid” />

<use id=“spiral” xlink:href=“#sp” x=“496” y=“510” style=“stroke:black”/>
<text id=“coolertext” style=“font-size:18pt” x=“515” y=“670”>
Cooler
</text>
<rect id=“cooler” x=“475” y=“680” width=“150” height=“80”

style=“fill:skyblue” />

<use id=“coolerspiral” xlink:href=“coolersp” style=“stroke:black” x=“485”

y=“695”/>

<text id=“mixertext” style=“font-size:18pt” x=“525” y=“840”>
Mixer
</text>
<use id=“mixer” xlink:href=“#mixerbase” x=“550” y=“900”/>
<text id=“tempT” style=“font-size:36pt” x=“960” y=“720”>Temp:</text>
<rect id=“”tempRect x=“975” y=“750” width=“100” height=“100”

style=“fill:none; stroke:black; stroke-width:2” />

<text id=“tempText” style=“font-size:62pt” x=“980” y=“835”>35</text>
<text id=“volT” style=“font-size:36pt” x=“60” y=“720”>Vol:</text>
<rect id=“volRect” x=“50” y=“750” width=“100” height=“100”

style=“fill:none; stroke:black; stroke-width:2” />

<text id=“volText” style=“font-size:62pt” x=“55” y=“835”>11</text>

Action 25: animation section, stipulates the objects which are animated using prime events or other events

<animateTransform id=“anim3” xlink:href=“Valve1”

attributeName=“transform” type=“rotate” from“0,441,156” to=“360,441,156” begin=“00:00:02”
dur=“2s” repeat-Count=“3”/>

<animateTransform id=“anim10” xlink:href=“#Valve2”

attributeName=“transform” type=“rotate” from=“0,661,156” to=“360,661,156” begin=“anim3.end”
dur=“2s” repeat-Count=“3” />

<animateTransform id=“anim11” xlink:href=“#fillingLevel”

attributeName=“transform” type=“scale” from=“1,1” to“1,0” begin=“anim3.begin” dur=“12s”
repeatCount=“1” fill=“freeze”/>

<animateTransform id=“anim12” xlink:href=“#mixer”

attributeName=“transform” type=“rotate” from=“360,550,900” to=“0,550,900”
begin=”anim10.end” dur=“1s” repeat-Count=“5” />

<set id=“anim14” xlink:href=“#spiral” attributeName=“stroke” to=“red”

begin=“anim12.end” dur=“5s” />

<set xlink:href=“#heatertext” attributeName=“stroke” to=“red”

begin=“anim14.begin” end=“anim14.end” />

<set id=“anim15” xlink:href=“#coolerspiral” attributeName=“stroke”

to=“blue” begin=“anim14.end” end=“anim13.end” />

<set xlink:href=“#coolertext” attributeName=“stroke” to=“blue

begin=“anim15.begin” end=“anim15.end” />

<animate id=“anim13” xlink:href=“#temperatur” attribute-Name=“fill”

values=“url(#BlendLinear3);url(#BlendLinear);url(#BlendLinear2);url(#BlendLinear);url(#BlendLi
near3)” keyTimes=“0; 0.25; 0.5; 0.75; 1” begin=“anim12.end” dur=“10s” />

<animateTransform id=“anim16” xlink:href=“#Valve3”

attributeName=“transform” type=“rotate” from“0,690,1262” to=“360,690,1262”
begin=“anim15.end” dur=“1s” repeat-Count=“5” />

<animateTransform id=“anim17” xlink:href=“#fillingLevel”

attributeName=“transform” type=“scale” from=“1,0” to=“1,1” begin=“anim15.end” dur=“5s”
fill=“freeze”/>

<set id=“anim5” xlink:href=“#temperatur” attributeName=“fill”

to=“url(#BlendLinear2)” begin=“heater.mouseover” end=“heater.mouseout” />

<set id=“anim8” xlink:href=“#temperatur” attributeName=“fill”

to=“url(#BlendLinear3)” begin=“cooler.mouseover” end=“cooler.mouseout” />

</g>
</svg>

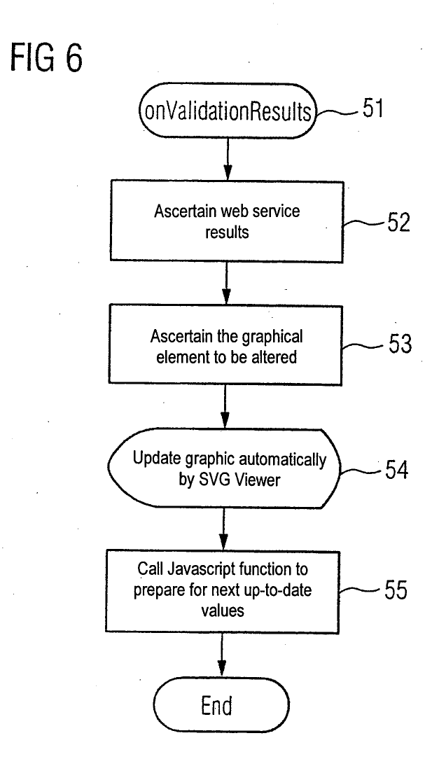

The connection between graphics and the process values is made as shown in FIGS. 4, 5 and 6 by simple scripting, as shown in the code excerpts below. This part represents/implements the actual O&O functionality. This script is executed in the browser on the client. It uses a web service, which is used to access the process values, and updates the values in the corresponding graphics elements.

FIG. 4:

Start 31: initialization routine when loading the SVG element into the browser

Function initVars (evt)
{

Action 32: set the global variable for access to the SVG document (=graphic)

svgdoc=evt.getTarget( ).getOwnerDocument( );

Action 33: initialize the web service behavior, which allows access to the process values

m Services = document.getElementByld(“web service.htc”); if
(m Services != null)

{

Action 34: initialize the “DataProvider” as representative of the web service for reading process values; store the access points for the web services which are to be used

m Services.useService(http://localhost/svg/SVGService/Service1.asmx?wsd1, “DataProvider”);

Action 35: call up the web service

CallService( );

...

}

}

FIG. 5:

Start 41: call up the function

function CallService( )
{

Action 42: call up the web service for ascertaining the current value of the temperature display

Action 43: the results of the call are processed in the callback function on ValidationResults

m Services.DataProvider.callService(onValidationRresults,
“GetModevalues”);
}

FIG. 6:

Start 51: callback function

function onValidationResults(result)
{

Action 52: ascertain web service results (temperature etc.)

var i;

i=result.value;

Action 53: ascertain the graphical element within the SVG document (DOM) whose value, appearance etc. needs to be altered

var svgElement=svgdoc.getElementBy Id(“tempText”);

Action 54: a change call to the element (the graphic is updated by SVG Viewer automatically)

svgElement.getFirstChild( ).setData(result.value.temp);

Action 55: prepare to pick up the next up-to-date values (in this case under time control) by again calling the Javascript function CallService, which in turn initiates the required web services.

SetTimeout(CallService, POLLOYCLE);
}

Besides this time-controlled procedure for reading process values using the web service, other mechanisms are possible. It is thus useful to use a small, short and hence very fast call to a web service in order to establish whether any process values have changed. Only then are the process values returned (in the same call or in a second call) and are the updated values used to modify the graphic if appropriate.

In summary, possible aspects of the invention relate to a system, to a method and also to a client and to a data processing apparatus for web-based presentation of data in a system for operating and observing a process. Up-to-date process values may be automatically transmitted by a server or an automation unit 1 to a client 2, on which they are visualized using scalable vector graphics and the application of SVG (Scalable Vector Graphics).

The invention has been described in detail with particular reference to preferred embodiments thereof and examples, but it will be understood that variations and modifications can be effected within the spirit and scope of the invention.

1. A system for presenting dynamic data for operating and observing a process, comprising:
a first apparatus to provide the dynamic data;
a second apparatus to receive the dynamic data, the second apparatus having a vector visualization unit to visualize the dynamic data with scalable vector graphics; and
a transmission apparatus to automatically transmit updated dynamic data from the first apparatus to the vector visualization unit of the second apparatus.

2. The system as claimed in claim 1, wherein the dynamic data is process data in an automated manufacturing process.

3. The system as claimed in claim 1, wherein the transmission apparatus comprises an intranet and/or the Internet.

4. The system as claimed in claim 1, wherein the first apparatus comprises a server.

5. The system as claimed in claim 4, wherein the server is a web server.

6. The system as claimed in claim 1, wherein the first apparatus comprises an automation unit with web server functionality.

7. The system as claimed in claim 1, wherein the second apparatus comprises a client.

8. The system as claimed in claim 1, wherein the second apparatus comprises a web client.

9. The system as claimed in claim 8, wherein the vector visualization unit comprises a browser.

10. The system as claimed in claim 1, wherein the vector visualization unit comprises a browser.

11. The system as claimed in claim 1, wherein the dynamic data is presentation data which is independent of screen resolution and/or of screen zoom factor.

12. The system as claimed in claim 1, wherein the scalable vector graphics are created at the second apparatus using a Scalable Vector Graphics SVG language.

13. The system as claimed in claim 1, wherein the dynamic data provided by the first apparatus is dynamic data for web services.

14. The system as claimed in claim 13, wherein the second apparatus calls the dynamic data from the first apparatus.

15. The system as claimed in claim 1, wherein the first apparatus provides updated dynamic data using hidden frames.

16. The system as claimed in claim 1, wherein the first apparatus transmits updated dynamic data to the second apparatus using a streaming media mechanism.

17. The system as claimed in claim 1, wherein the second apparatus and the transmission apparatus comprise wireless communication units.

18. The system as claimed in claim 1, wherein the first apparatus comprises a web server.

19. The system as claimed in claim 3, wherein the first apparatus comprises an automation unit with web server functionality.

20. The system as claimed in claim 19, wherein the second apparatus comprises a web client.

21. The system as claimed in claim 20, wherein the vector visualization unit comprises a browser.

22. The system as claimed in claim 21, wherein the dynamic data is presentation data which is independent of screen resolution and/or of screen zoom factor.

23. The system as claimed in claim 22, wherein the scalable vector graphics are created at the second apparatus using a Scalable Vector Graphics SVG language.

24. The system as claimed in claim 23, wherein the dynamic data provided by the first apparatus is dynamic data for web services.

25. The system as claimed in claim 24, wherein the second apparatus calls the dynamic data from the first apparatus.

26. The system as claimed in claim 24, wherein the first apparatus provides updated dynamic data using hidden frames.

27. The system as claimed in claim 23, wherein the first apparatus transmits updated dynamic data to the second apparatus using a streaming media mechanism.

28. The system as claimed in claim 27, wherein the second apparatus and the transmission apparatus comprise wireless communication units.

29. A method for presenting dynamic data for operating and observing a process, comprising:
providing dynamic data from a first apparatus;
transmitting the dynamic data from the first apparatus to a second apparatus using a transmission medium;
receiving the dynamic data at the second apparatus;
visualizing the dynamic data at the second apparatus using scalable vector graphics; and
automatically transmitting updated dynamic data from the first apparatus to the second apparatus.

30. The method as claimed in claim 29, wherein the dynamic data is transmitted via an intranet and/or the Internet.

31. The method as claimed in claim 29, wherein the first apparatus is a web server.

32. The method as claimed in claim 29, wherein the first apparatus is an automation unit with web server functionality.

33. The method as claimed in claim 29, wherein the second apparatus is a web client, and/or the dynamic data are visualized by a browser.

34. The method as claimed in claim 29, wherein the dynamic data are presentation data, which are independent of screen resolution and/or of screen zoom factor.

35. The method as claimed in claim 29, wherein the dynamic data are visualized using a Scalable Vector Graphics SVG language.

36. The method as claimed in claim 29, wherein the dynamic data provided by the first apparatus are dynamic data for web services.

37. The method as claimed in claim 29, wherein
the dynamic data provided by the first apparatus are in the form of web services, and
the dynamic data are called up by a visualization unit.

38. The method as claimed in claim 29, wherein updated dynamic data are transmitted using hidden frames.

39. The method as claimed in claim 29, wherein the updated dynamic data are transmitted to the second apparatus using a streaming media mechanism.

40. The method as claimed in claim 29, wherein wireless communication is used to transmit the dynamic data to the second apparatus.

41. A client for presenting dynamic data for operating and observing a process, comprising:
a reception device to automatically receive the dynamic data via a transmission apparatus; and
a visualization unit to visualize the dynamic data using scalable vector graphics.

42. The client as claimed in claim 41, wherein the client is a web client and/or the visualization unit is a browser.

43. The client as claimed in claim 41, wherein the dynamic data is presentation data which is independent of screen resolution and/or of screen zoom factor.

44. The client as claimed in claim 41, wherein the visualization unit creates scalable vector graphics using a Scalable Vector Graphics SVG language.

45. The client as claimed in claim 41, wherein the reception device comprises a wireless communication unit.

46. A data processing apparatus with web server functionality, comprising:
a server unit to provide dynamic data for operating and observing a fabrication process in an automation environment; and
a transmission unit to automatically transmit the dynamic data and updated dynamic data to a second apparatus.

47. The data processing apparatus as claimed in claim 46, wherein the transmission apparatus transmits via an intranet and/or the Internet.

48. The data processing apparatus as claimed in claim 46, wherein the transmission unit provides dynamic data in the form of web services.

49. The data processing apparatus as claimed in claim 46, wherein
the dynamic data is in the form of web service data, and
the server unit provides the dynamic data when it is called up by the second apparatus.

50. The data processing apparatus as claimed in claim 46, wherein updated dynamic data is provided using hidden frames.

51. The data processing apparatus as claimed in claim 46, wherein updated dynamic data is provided using streaming media.
